(19) United States
(12) Patent Application Publication
(10) Pub. No.: US 2016/0132370 A1
(43) Pub. Date: May 12, 2016

(54) METHOD AND APPARATUS FOR PROVIDING APPLICATION NOTIFICATIONS

(71) Applicant: Nokia Technologies Oy, Espoo (FI)

(72) Inventors: Tuomas Veli KESKITALO, Oulunsalo (FI); Tommi HEINONEN, Oulu (FI)

(21) Appl. No.: 14/965,445

(22) Filed: Dec. 10, 2015

Related U.S. Application Data
(63) Continuation of application No. 13/665,516, filed on Oct. 31, 2012.

(51) Int. Cl. G06F 9/54; G06F 3/0484

(52) U.S. Cl. CPC G06F 9/546; G06F 3/0484

(57) ABSTRACT

An approach is provided for distributing notifications from developers to installed applications via a notification enabler separate from the applications. The notification platform determines at least one application installed on at least one device. Then, the notification platform causes, at least in part, a subscription via at least one notification enabler to one or more notification channels associated with the at least one application, wherein the at least one notification enabler is a separate component from the at least one application.

### CROSS REFERENCE TO RELATED APPLICATIONS

This application is a continuation of U.S. patent application Ser. No. 13/665,516, filed Oct. 31, 2012, titled “Method and apparatus for providing application notifications”, which is incorporated herein by reference in its entirety.

### BACKGROUND

Service providers and device manufacturers (e.g., wireless, cellular, etc.) are continually challenged to deliver value and convenience to consumers by, for example, providing compelling network services. One area of interest has been the development of distributing messages to applications, including notifications. For example, push notifications are essential for application developers to communicate with end user devices. However, traditional push notifications require both service and client development. For example, each application must independently include services to support notifications. As a result, service providers face significant challenges developing notification services independently for individual applications.

### SOME EXAMPLE EMBODIMENTS

Therefore, there is a need for an approach for distributing notifications from developers to installed applications via a separate notification enabler.

According to one embodiment, a method comprises determining at least one application installed on at least one device. The method also comprises causing, at least in part, a subscription via at least one notification enabler to one or more notification channels associated with the at least one application, wherein the at least one notification enabler is a separate component from the at least one application.

According to another embodiment, an apparatus comprises at least one processor, and at least one memory including computer program code for one or more computer programs, the at least one memory and the computer program code configured to, with the at least one processor, cause, at least in part, the apparatus to determine at least one application installed on at least one device. The apparatus is also caused to cause, at least in part, a subscription via at least one notification enabler to one or more notification channels associated with the at least one application, wherein the at least one notification enabler is a separate component from the at least one application.

According to another embodiment, a computer-readable storage medium carries one or more sequences of one or more instructions which, when executed by one or more processors, cause, at least in part, an apparatus to determine at least one application installed on at least one device. The apparatus is also caused to cause, at least in part, a subscription via at least one notification enabler to one or more notification channels associated with the at least one application, wherein the at least one notification enabler is a separate component from the at least one application.

According to another embodiment, an apparatus comprises means for determining at least one application installed on at least one device. The apparatus also comprises means for causing, at least in part, a subscription via at least one notification enabler to one or more notification channels associated with the at least one application, wherein the at least one notification enabler is a separate component from the at least one application.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of distributing notifications from developers to installed applications via a notification enabler separate from the applications, according to one embodiment;

FIG. 2A is a diagram of the components of a notification platform, according to one embodiment;

FIG. 2B is a diagram of the components of a composer platform, according to one embodiment;

FIG. 3 is a flowchart of a process for distributing notifications from developers to installed applications via a notification enabler separate from the applications, according to one embodiment;

FIG. 4 is a flowchart of a process for distributing notifications from developers to installed applications via a notification enabler separate from the applications, according to one embodiment;

FIG. 5 is a flowchart of a process for distributing notifications from developers to installed applications via a notification enabler separate from the applications, according to one embodiment;

FIG. 6 is a flowchart of a process for distributing notifications from developers to installed applications via a notification enabler separate from the applications, according to one embodiment;

FIG. 7 is an illustration of the processes of FIGS. 3-6, according to various embodiments;

FIG. 8 is an illustration of the processes of FIGS. 3-6 from a user device viewpoint, according to various embodiments;

FIGS. 9A-9E are diagrams of user interfaces utilized in the processes of FIGS. 3-6, according to various embodiments;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for distributing notifications from developers to installed applications via a separate notification enabler are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

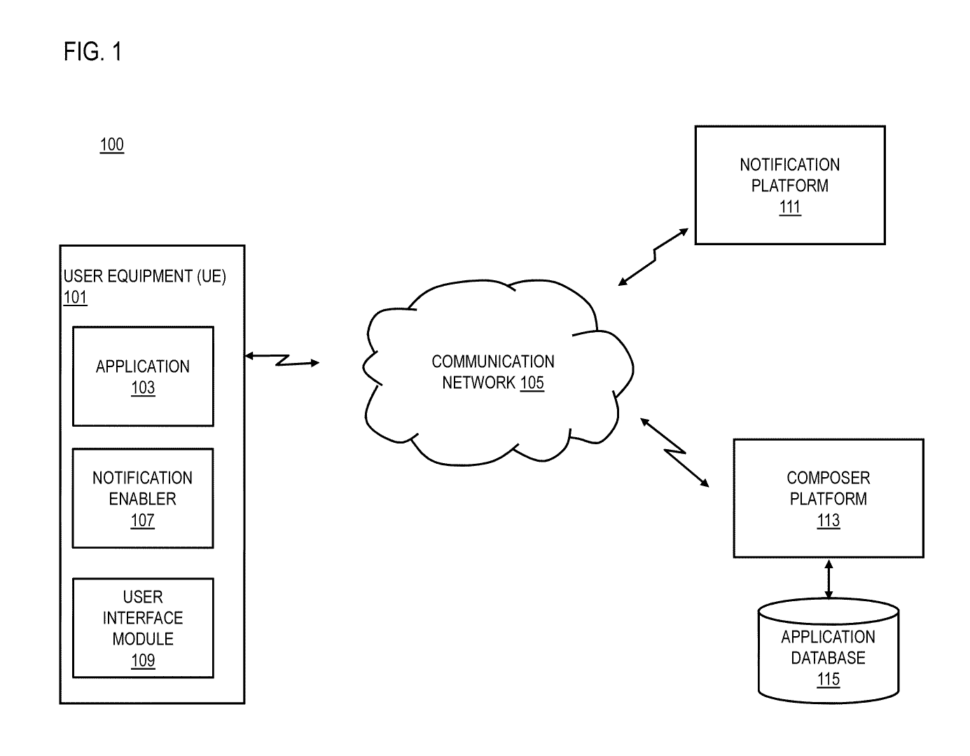

FIG. 1 is a diagram of a system capable of distributing notifications from developers to installed applications via a notification enabler separate from the applications, according to one embodiment. Applications are commonly used in devices, and each application is individually configured to receive notifications, for instance by way of an application programming interface (API). For example, before an application can receive notifications, it must register with a notification server. An application may then call a client API to register itself and request a unique notification identifier. The notification identifier may be unique to the end user and application, and the notification server may rely on the notification identifier to route notifications. The application then associates the notification identifier with a notification service associated with the application, thus informing the notification server of where to send notifications. To distribute a notification then, the developers send the notification to the notification server using a service API, along with the notification message itself as well as the notification identifier. Using the notification identifier, the notification server sends the notification to the client application.

In this method, developers need to program push notification capability for each application. The applications then independently push the notifications to the user. In providing push notification capability, developers also need to include supporting functionalities including registration, notification service integration, etc. For example, pushing notifications to users may include sound, onscreen alert, or an icon denoting the presence of application notifications. Thus, one problem is continually requiring developers to equip applications with push notification capability to applications, along with functionalities supporting push notification capability. Consequently, each application may employ a different notification service or redundant APIs on both the end user and client side.

To address this problem, a system 100 of FIG. 1 introduces the capability to distribute notifications from developers to installed applications via a notification enabler separate from the applications. In one embodiment, the system 100 thus eliminates at least a developer API such end users may receive messages for applications directly from an application channel, rather than requiring each end user to support push notification API communication with developer APIs to transmit each message. In one embodiment, the notification enabler may subscribe a device to an application notification channel.

For application notification channels, the system 100 may create one or more notification channels associated with one or more applications. In one embodiment, each application is associated with one notification channel. In another embodiment, each application may be associated with multiple notification channels. For example, a game application may be associated with one notification channel tailored to updates occurring in the game itself, another notification channel specifically for updates in the application itself, and a third notification channel regarding other users in a social network group that may be active in the game. For another example, each notification channel may also potentially serve multiple applications. For instance, a notification channel announcing updates may apply to all the applications associated with a particular application developer.

In one embodiment, the system 100 may provide a console, separate from an application, where publishers may send messages (including notifications) to the applications. Publishers may include any entities with authority to send messages relating to the applications. For example, publishers may include application owners, application developers, or a combination thereof. In one embodiment, the console includes a web console interface separate from application servers where publishers may easily compose a message. In one embodiment, the system 100 may require the publisher to register and to verify that it is, in fact, the publisher. Based on the publisher registration, the system 100 may identify the publisher and thus provide the console with applications associated with the publisher. For example, such applications may include all the applications made by a specific application developer or owned by a particular application owner. The applications may be fetched from an application database, for instance, an application store. Alternately, the system 100 may provide the applications associated with the publisher, within a certain grouping. For example, a given application developer may have developed applications that were games and news outlets. The system 100 may be set to retrieve only notifications relating to news outlets.

In one embodiment, the system 100 may create a channel for each application to a notification server such that messages entered through the console may be sent to the applications. In one embodiment, the system 100 may distribute the messages to all the end users (or devices) that have installed the application. In another embodiment, the system 100 may distribute the messages to end users that have subscribed to the channels associated with the applications. For example, the system 100 may prompt an application to subscribe to an application channel upon installation. Subscribing to the channel may permit a notification enabler to retrieve a message published to the channel, and thus display the message at a mobile device.

In one embodiment, the system 100 may permit end users to choose subscriptions and subscription settings. For example, upon installation of an application, the system 100 may prompt an end user to select whether or not to subscribe to a channel to receive notifications from the application. In one scenario, the prompt may take the form of an “acceptance” window. In another example, the system 100 may prompt the end user to select whether or not to subscribe upon the first notification. For instance, an application may be installed on a user device for a period of time before a developer sends an update notification. Then, the system 100 may route the update notification through the channel to an application installed on a device, at which point the system 100 may create an “acceptance” window for the end user to select whether or not to continue to receive notifications.

In one embodiment, the initial acceptance window may include a request for preference information associated with the messages, subscription, or a combination thereof. For example, the system 100 may prompt end users to select message frequency, message type, message display options, or a combination thereof. Message frequency may refer to how often the end user may permit notifications from an application channel, for instance daily, weekly, monthly, etc. Message type may include text-only messages, rich notification messages, or a combination thereof. Message display options may pertain to whether the message is a pop-up overlaid on the screen, as a scrolling line, a small preview window, etc. In one embodiment, system 100 may also integrate display options with notification services available at the end user devices and/or applications with API for supporting notifications.

In one embodiment, the system 100 may determine contextual information associated with notification channels, end user device, applications, or a combination thereof. For example, contextual information may include technical specifications including available bandwidth or type of notifications supported. In such a scenario, a given channel may be devoted to text-only messages for low bandwidth devices and/or settings. Alternately, contextual information may include information such as location information associated with devices. Then, the system 100 may help developers target notifications, for example, to a certain geographic area. Other contextual information along these lines may include user profile information, user device activity information, or a combination thereof.

In a further embodiment, the system 100 may further target messages and notifications by profiling end users. For example, the system 100 may profile users according to attributes associated with applications (or groups of applications) installed on devices associated with the users. The system 100 may also profile users according to user interaction with notifications. In one scenario, the system 100 may determine that a given user does not respond to notifications, whereas another user tends to frequently click on links or media offered in notifications. The system 100 may then send notifications more frequently to the second user, rather than the first.

As shown in FIG. 1, the system 100 comprises a user equipment (UE) 101 having connectivity to an application 103, a notification enabler 107, a user interface module 109, a notification platform 111, a composer platform 113, and an application database 115 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the application 103 is any application installed on a device, including UE 101. In one embodiment, the application 103 may be in connectivity with the notification enabler 107 such that the notification enabler 107 may relate to the notification platform 111 that application 103 has been installed successfully at UE 101. In one embodiment, the notification enabler 107 may even participate in the installation of application 103, where applications that are installed with the aid of notification enabler 107 are in contact with notification platform 111. In another embodiment, notification enabler 107 may simply determine that an application, including application 103, has been installed on UE 101, and then notify notification platform 111 of the installation. In one embodiment, user interface module 109 may aid in displaying notifications and/or initial subscription “acceptance” messages where the notification platform 111 may prompt the user to establish settings associated with notification channel subscriptions or displays. For example, the notification enabler 107 may work with the user interface module 109 to prompt the user to establish settings upon installation. In another example, the notification enabler 107 may track the number of application installations and initiate subscription setting prompts only after a predefined number of installations have been successful.

In one embodiment, the notification enabler 107 may subscribe application 103 (and UE 101) to the notification platform 111, where the notification platform 111 may then distribute messages to channels managed by the composer platform 113. In one embodiment, the notification platform 111 may manage channel subscriptions, where subscribing UEs 101 and applications 103 may receive messages distributed to the channels. In one embodiment, composer platform 113 may create and establish the notification channels. In one embodiment, the composer platform 113 may maintain one channel per application. In another embodiment, the composer platform 113 may create one or more channels associated with one or more applications. In one embodiment, UE 101 and application 103 subscription to the notification platform 111 may include the notification enabler 107 registering the UE 101 and application 103 to the notification platform 111. Such registration may include obtaining an application identifier associated with application 103 and a device identifier associated with UE 101, or a combination thereof. Notification platform 111 may then route messages from the composer platform 113 based on the registration. For example, notification platform 111 may route messages to the UE 101 based on settings established by the notification enabler 107 at the notification platform 111 during the initial “acceptance” messages.

In one embodiment, the composer platform 113 may allow publishers to send messages (including notifications) to the applications 103 via channels managed by the composer platform 113, connected to UEs 101 via channel subscriptions created at the notification platform 111. In other words, the system 100 may send publisher messages over a connection between a notification backend (including the notification enabler 107 and notification platform 111) and the composer backend (including the composer platform 113). In one embodiment, the composer platform 113 may provide publishers with a console interface. For example, one or more console interfaces may be associated with at least one application. The console interface may include a web console interface where publishers may easily create and design messages without application APIs developed for each application. The UE 101 may then route the message to the application 103, where the user interface module 109 then displays the message.

In one embodiment, the application database 115 may manage all the applications available, for instance, in an applications store. Then, the composer platform 113 may interact with the application database 115 to form notification channels associated with the applications, or modify notification channels according to changes in the applications stored in the application database 115. In one embodiment, the application database 115 may also organize the applications. For example, the application database 115 may categorize the applications, for instance, by associated application developers, application owners, publishers, devices installed, or a combination thereof.

By way of example, the UE 101, application 103, notification enabler 107, user interface module 109, notification platform 111, composer platform 113, and application database 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

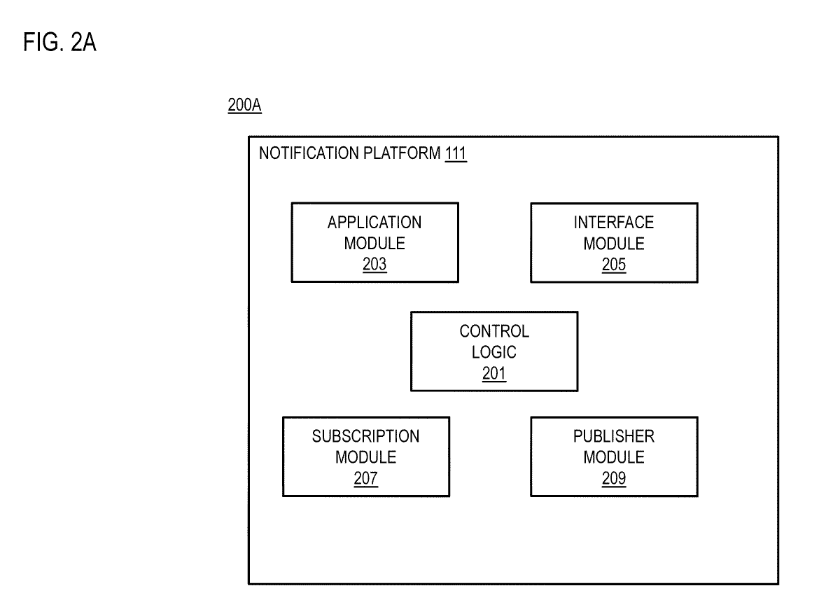

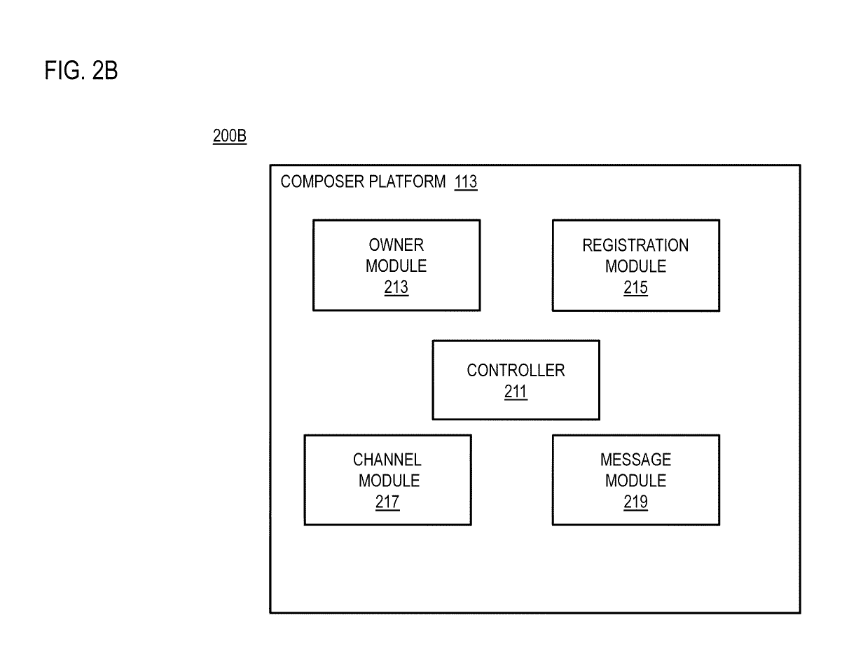

FIG. 2A is a diagram of the components of the notification platform 111, according to one embodiment. By way of example, the notification platform 111 includes one or more components for providing notification distribution via a separate notification enabler by keeping track of mobile device subscriptions to notification channels. It is contemplated that the functions of these components may be combined in one or more components or performed by other components of equivalent functionality. In this embodiment, the notification platform 111 includes an application module 203, registration module 205, subscription module 207, and publisher module 209. The control logic 201 executes at least one algorithm for executing functions at the notification platform 111.

In one embodiment, the control logic 201 may determine the subscriptions between application channels and applications installed on mobile devices. In one embodiment, the control logic 201 and application module 203 may determine at least one application installed on at least one device. For example, the notification enabler 107 may contact the control logic 201 and application module 203 upon successful installation of at least one application. In one embodiment, the control logic 201 and application module 203 may identify the application in the application database 115 and/or associated applications. In one embodiment, the control logic 201 and registration module 205 may then cause a registration of at least on application identifier associated with the application, at least one device identifier associated with at least one device, or a combination thereof, where routing of messages over notification channels is based on the registration. For instance, each application may be associated with one application identifier and one notification channel. In this case then, registering a device identifier with the notification channel associated with the one application identifier may permit messages from the one application to be routed to the one device (associated with the one device identifier), over the notification channel. Alternately, several devices (denoted by several device identifiers) may register under one application identifier since the application was installed on all the devices. The control logic 201 and registration module 205 may then route messages via notification channels associated with the application, to all the registered devices. In another embodiment, application identifiers may be unique to each application installed on each device. Then, the control logic 201 and registration module 205 may register each application identifier to an associated application notification channel to receive messages.

In one embodiment, the control logic 201 and subscription module 207 contain and manage the various subscriptions associated with the registration. For example, the control logic 201 and subscription module 207 may cause a subscription to notification channels associated with at least one application, at least one device, and/or groupings of applications or devices. In one embodiment, the control logic 201 and subscription module 207 may initiate subscription or registration (with the help of the registration module 205) when a number of installations have been successful. For example, the control logic 201 may establish a predefined number of installations, where the notification enabler 107 may communicate with the control logic 201 and application module 203 upon reaching a given number of successful installations. One such scenario may include where notification enabler 107 has successfully installed a pre-set number of applications associated with a particular application owner, developer, or publisher. Another such scenario may include where control logic 201 and application module 203 determine that a given application has been installed at a pre-set number of devices.

In one embodiment, the control logic 201 and subscription module 207 may determine settings associated with the subscriptions. For example, the control logic 201 and subscription module 207 may determine that one or more messages routed to a given device constitutes an initial message, and thus cause a request for preference information associated with messages, the subscription to channels, or a combination thereof. For example, the control logic 201 and subscription module 207 may prompt, via a user interface presentation, the selection of settings including message frequency, subscription to one or more channels, types of messages receivable (text, image, video, etc.), or a combination thereof. The control logic 201 and subscription module 207 may then manage the individualized subscriptions that various applications and/or devices maintain with various notification channels.

In another embodiment, the control logic 201 and publisher module 209 may retrieve a message from the composer platform 113, and publish the message at the associated devices and installed applications via the notification channel. In one embodiment, the control logic 201 and publisher module 209 may take into account notification services already available in the devices and applications. For example, the control logic 201 and publisher module 209 may ensure that the message received from the composer platform 113 is compatible with the receiving devices and applications. As previously discussed, the user interface module 109 may cause the application to show the message on the device interface. In a further embodiment, the control logic 201, subscription module 207, and publisher module 209 may monitor interactions with the notifications as received from the UEs 101 and adjust subscription settings and/or notifications based on the monitoring.

FIG. 2B is a diagram of the components of the composer platform 113, according to one embodiment. By way of example, the composer platform 113 includes one or more components for providing notification channels. It is contemplated that the functions of these components may be combined in one or more components or performed by other components of equivalent functionality. In this embodiment, the composer platform 113 includes publisher module 213, a validation module 215, a channel module 217, and a message module 219. The control logic 201 executes at least one algorithm for executing functions at the composer platform 113.

In one embodiment, the controller 211 and publisher module 213 may fetch, from the application database 115, all the applications associated with one or more entities with authorization to send messages to the applications. The entities may be, for example, application owners, application developers, application publishers, or a combination thereof. For instance, the application developer may sign into an interface where the controller 211 and publisher module 213 may recognize the application owner as being the developer of one or more other applications. In one embodiment, the controller 211 and validation module 215 may seek verification from the developer to certify authorization to distribute messages to the associated application. For example, the controller 211 and validation module 215 may require login and password information to certify that a registrant is, in fact, the application developer.

In one embodiment, the controller 211 and channel module 217 may then create one or more channels based, at least in part, on applications identified as associated with the one or more given owners, including applications given by the application database 115. In one embodiment, the one or more channels are notification channels for distributing notifications from application developers to end users and mobile devices where associated applications are installed. For example, the controller 211 may create notification channels based, at least in part, on identification of at least one application, publishers associated with the at least one application, or a combination through an application store. For such a case, there may be one or more channels for every identified application, for instance, the controller 211 and channel module 217 may create one or more channels associated with every application in application database 115. For another instance, the controller 211 and channel module 217 may create channels based on validation of one or more publishers based on the identification, at least one application store, or a combination thereof. In one such case, the controller 211 and channel module 217 may create a channel for each of the applications found to be attributable to the validated publishers. In other words, the controller 211 and channel module 217 may create groupings of applications and create channels according to the groupings.

Furthermore, the controller 211 and channel module 217 may cause an association of contextual criteria with the notification channels. For instance, notification channels may be created based on contextual criteria, including bandwidth, notification type (push or rich notifications), content (text, image, or video), or a combination thereof. In another embodiment, the controller 211 and channel module 217 may cause, at least in part, routing of messages over the notification channels based, at least in part, on whether contextual information associated with the at least one device, the at least one application, or a combination thereof at least substantially meets the one or more contextual criteria. For example, controller 211 may determine from contextual information associated with at least one device, that the device does not have adequate bandwidth to receive a given message. In this case, the controller 211 and channel module 217 may employ a comparable message over another notification channel associated with messages that require less bandwidth.

In one embodiment, the controller 211 and message module 219 may create a console interface for the publisher to enter his message. In one instance, the console interface may include, at least in part, a web console interface separate from one or more application servers associated with at least one application. For example, without directly accessing an application, a publisher may enter the console interface, validate his identify as a publisher via the interface (and publisher module 213), and compose a notification that may then be distributed via the channels created by the channel module 217.

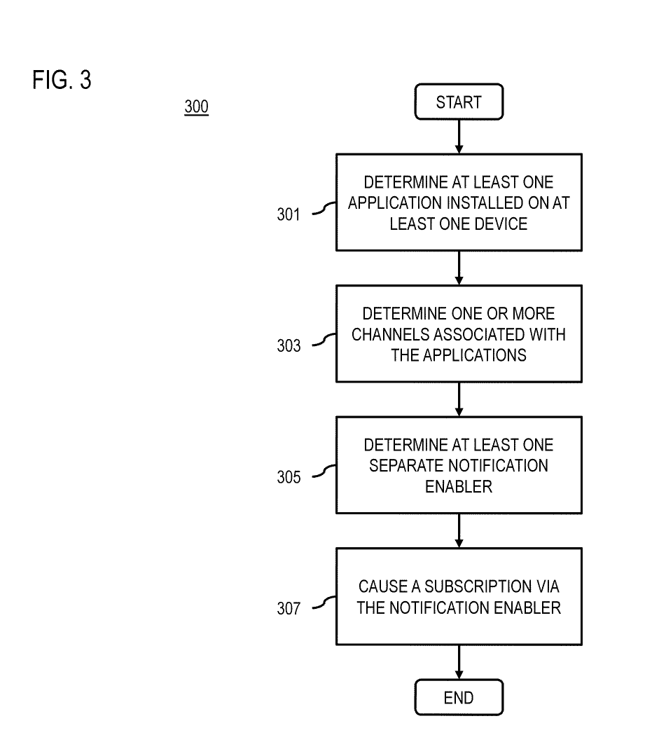

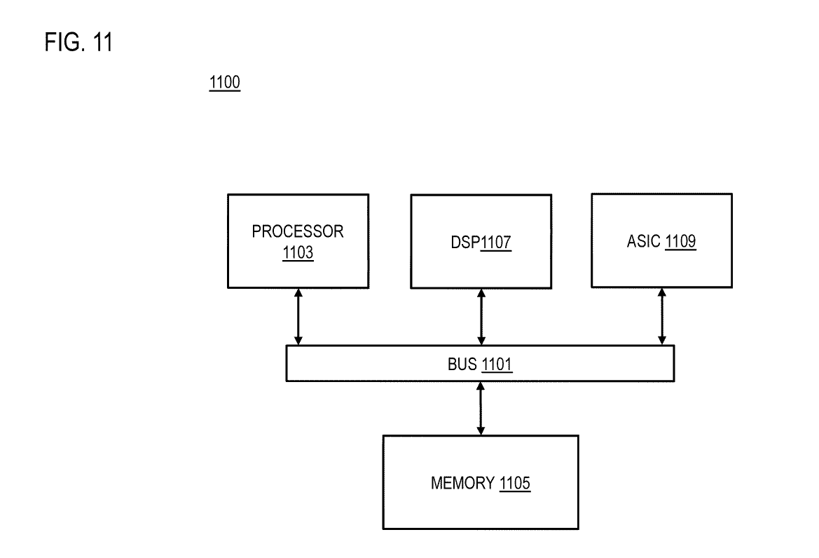

FIG. 3 is a flowchart of a process for distributing notifications from developers to installed applications via a separate notification enabler, according to one embodiment. In one embodiment, the notification platform 111 performs the process 300 and is implemented in, for instance, a chip set including a processor and a memory as shown in FIG. 11. In step 301, the control logic 201 may determine at least one application installed on at least one device. Based on the application, the control logic 201 may determine one or more notification channels associated with the at least one application (step 303). Upon determining one or more notification channels associated with the at least one application, the control logic 201 may cause, at least in part, a subscription via at least one notification enabler to one or more notification channels associated with the at least one application, wherein the at least one notification enabler is a separate component from the at least one application (steps 305-307). For instance, the control logic 201 may determine notification channels associated with an application, and connect UEs 101 to the channels via subscriptions. For example, notification enabler 107 subscriptions to a notification channel at notification platform 111 may permit control logic 201 and notification enabler 107 to retrieve messages published to the channels.

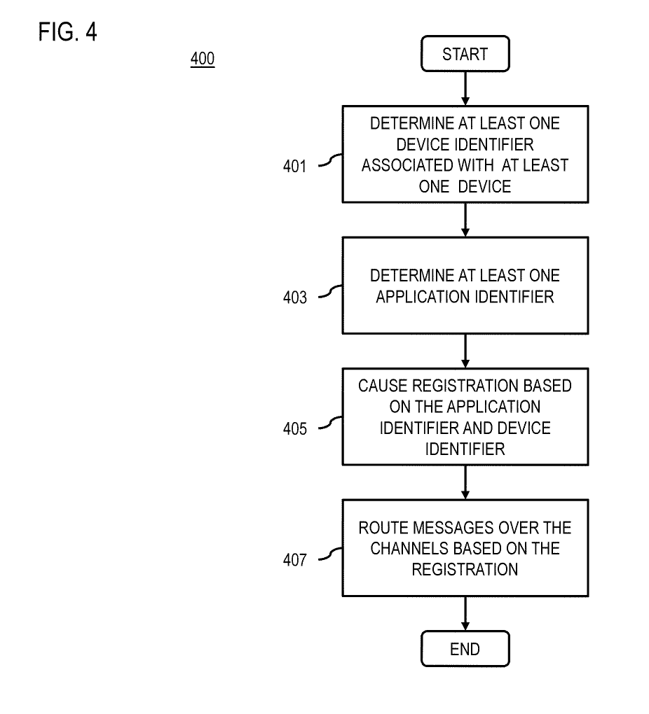

FIG. 4 is a flowchart of a process for creating subscriptions to notification channels, according to one embodiment. In one embodiment, the notification enabler 107 performs the process 400 and is implemented in, for instance, a chip set including a processor and a memory as shown in FIG. 11. In one embodiment, the notification enabler 107 may cause, at least in part, a registration of at least one application identifier associated with the at least one application, at least one device identifier associated with the at least one device, or a combination thereof; and cause, at least in part, a routing of one or more messages over the one or more notification channels based, at least in part, on the registration (steps 401-407). For example, the notification enabler 107 may request specific identifiers from the device and application to construct subscriptions according to user specifications. As previously discussed, users may specify particular settings, including notification frequency, type, etc. The notification enabler 107 may create distinct subscriptions identified via the registration information including application and device identifiers.

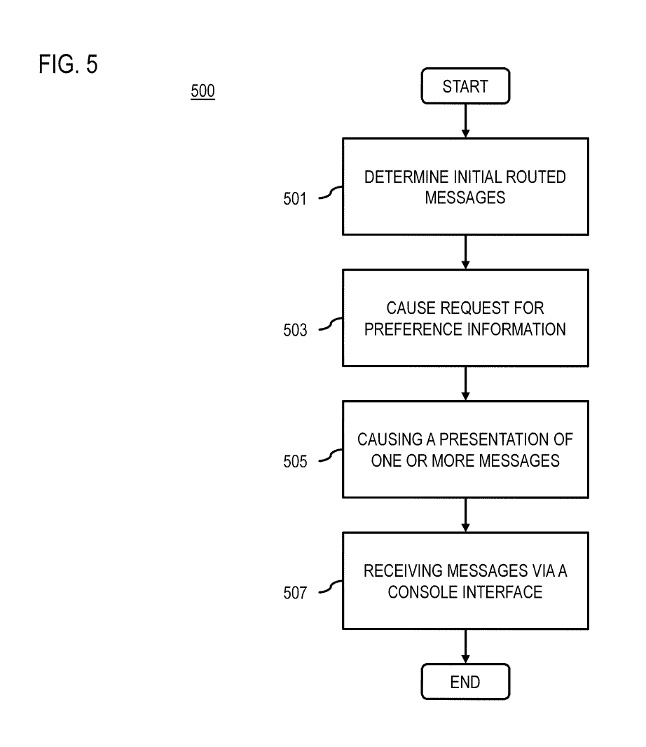

FIG. 5 is a flowchart of a process for distributing messages from publishers according to user settings and preferences, according to one embodiment. In one embodiment, the notification platform 111 performs the process 500 and is implemented in, for instance, a chip set including a processor and a memory as shown in FIG. 11. In one embodiment, the control logic 201 may cause, at least in part, a presentation of the one or more messages in a notification user interface associated with the at least one notification enabler. In doing so, the control logic 201 may determine that the one or more messages include, at least in part, one or more initial messages routed to the at least one application, the at least one device, or a combination thereof (step 501). For example, control logic 201 may determine that a message will be the first message a UE 101 will be receiving from a given application since the UE 101 and application were registered to subscribe to the application notification channel. Then, the control logic 201 may cause, at least in part, a request for preference information associated with the one or more messages, the subscription to the one or more notification channels, or a combination thereof, wherein the one or more messages is based, at least in part, on the preference information (steps 503-505). In one embodiment, the control logic 201 may pair preference information with registration information such that preferences indicated for a specific device, are associated with the device and applied for relevant application notification distribution.

In one embodiment, the subsequent presentation of messages may include the control logic 201 receiving the one or more messages via a console interface presented to one or more publishers associated with the at least one application. In one embodiment, the console interface may be wherein the console interface includes, at least in part, a web console interface that is separate from one or more application servers associated with the at least one application (step 507).

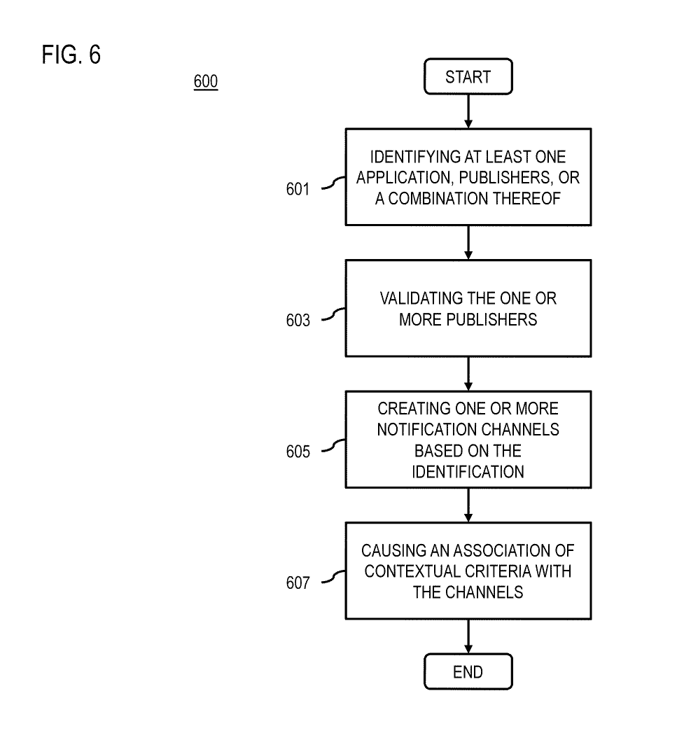

FIG. 6 is a flowchart of creating channels in accordance with publisher information and contextual criteria, according to one embodiment. In one embodiment, the composer platform 113 performs the process 600 and is implemented in, for instance, a chip set including a processor and a memory as shown in FIG. 11. In one embodiment, the controller 211 may cause, at least in part, an identification of the at least one application, one or more publishers associated with the at least one application, or a combination thereof through at least one application store and cause, at least in part, a creation of the one or more notification channels based, at least in part, the identification (step 601). The controller 211 may also cause, at least in part, a validation of the one or more publishers based, at least in part, on the identification, the at least one application store, or a combination thereof, wherein the creation of the one or more notification channels is further based, at least in part, on the validation (steps 603-605). Additionally, the controller 211 may cause, at least in part, an association of one or more contextual criteria with the one or more notification channels (step 607). As previously discussed, the controller 211 may determine contextual criteria associated with the notification channels, UEs 101, or applications. For example, controller 211 may determine location information associated with the UEs 101 and target messages according to the location information. In another example, controller 211 may profile users based on installed applications and tailor messages according to the profiles. Thus for step 607, the controller 211 may cause, at least in part, a routing of one or more messages over the one or more notification channels based, at least in part, on whether contextual information associated with the at least one device, the at least one application, or a combination thereof at least substantially meets the one or more contextual criteria.

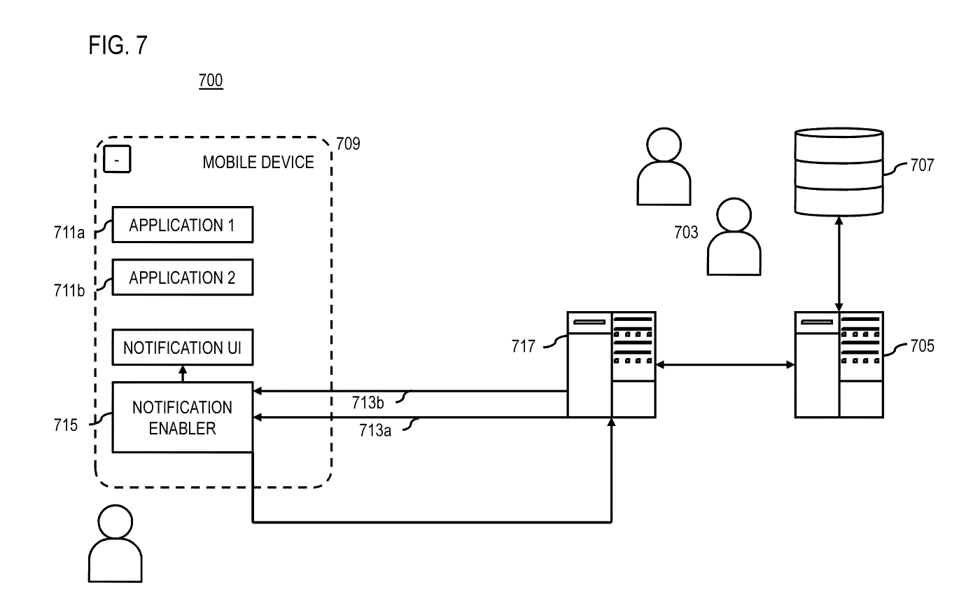

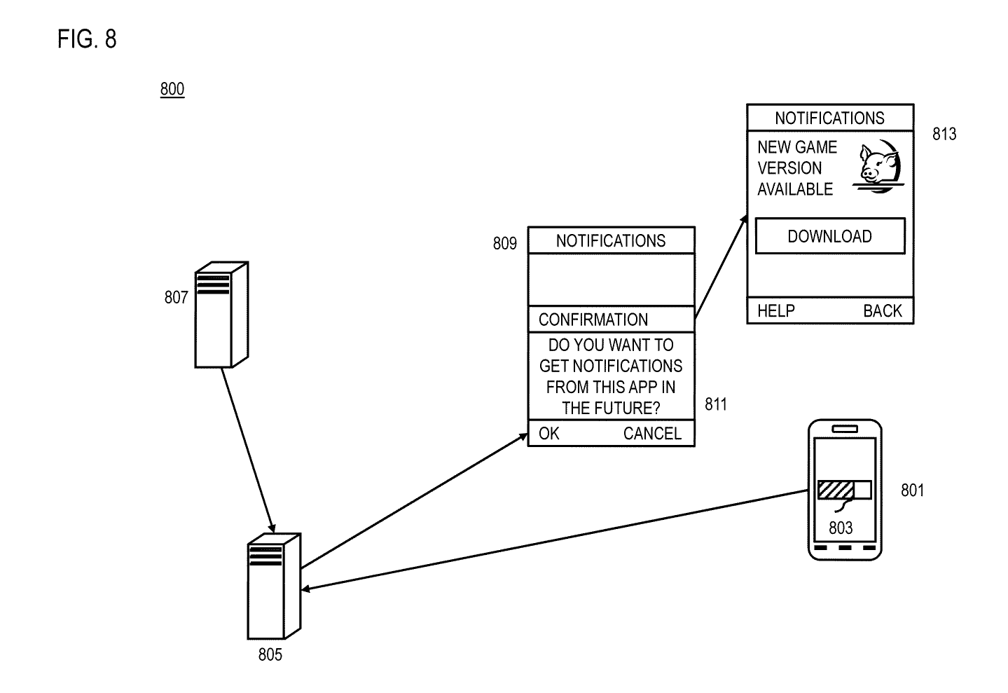

FIGS. 7 and 8 are illustrations of the processes of FIG. 3, according to various embodiments. FIG. 7 shows one embodiment where publishers 703 may initiate use of a composer 705, including a composer like the composer platform 113. To help publishers 703 in constructing their message, the composer 705 may interact with an application database, for example, application store 707. For instance, composer 705 may fetch all the applications associated with given publishers 703, from application store 707.

Mobile device 709 may have installed on it, application 711a and 711b. In one embodiment, the composer 705 may then create a channel 713a from installed application 711a to the notification server 713. In one embodiment, the composer 705 creates a channel for each application, creating channels 713a and 713b. The notification enabler 715 may then subscribe the installed applications to associated channels. For example, the notification enabler 715 may subscribe installed application 711a to associated channel 713a and installed application 711b has one associated channel 713b. The notification server 717 may manage all the subscriptions of installed applications, to associated application channels.

The composer 705 may then publish messages to the notification server 717, from which a notification enabler 715 may retrieve the messages, based on its subscriptions to the notification server 717. In this way, the publishers 703 may send notifications to all the end user devices 709 that have installed the applications, and channel subscriptions are centralized in the notification server 717 rather than individual application APIs.

FIG. 8 shows one embodiment where a user installs an application 801 and enabler 803 receives notification that installation was successful. Then, the enabler 803 may subscribe the user to a corresponding application channel at notification backend 805. The channel may involve the composer backend 807 noting all the installed applications, and creating a notification for all the installed applications (or all the customers that have installed the application). After creating the notification, the composer backend 807 may publish the notification to the channel. In one scenario, the notification may be the first notification 809 the user receives from the application. In this case, the first notification 809 may include an acceptance or confirmation window 811 where the user may choose whether to subscribe to the application channel. Should the user elect to subscribe, the composed notification 813 may be displayed to the user. In one embodiment, the composed notification 813 may include rich notifications and include links, video, maps, etc.

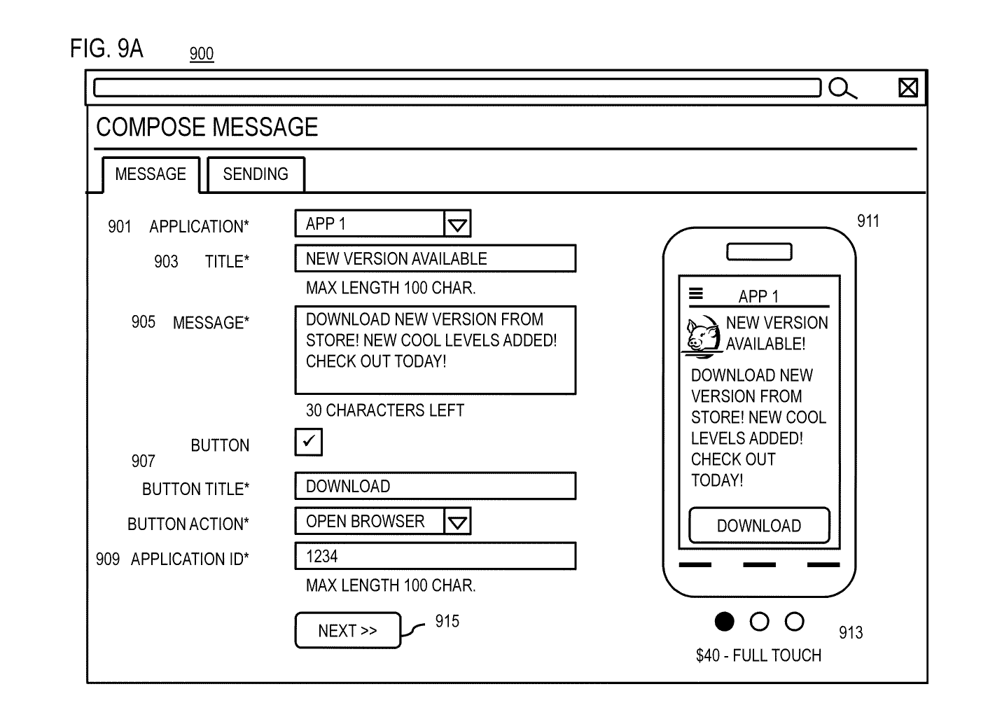

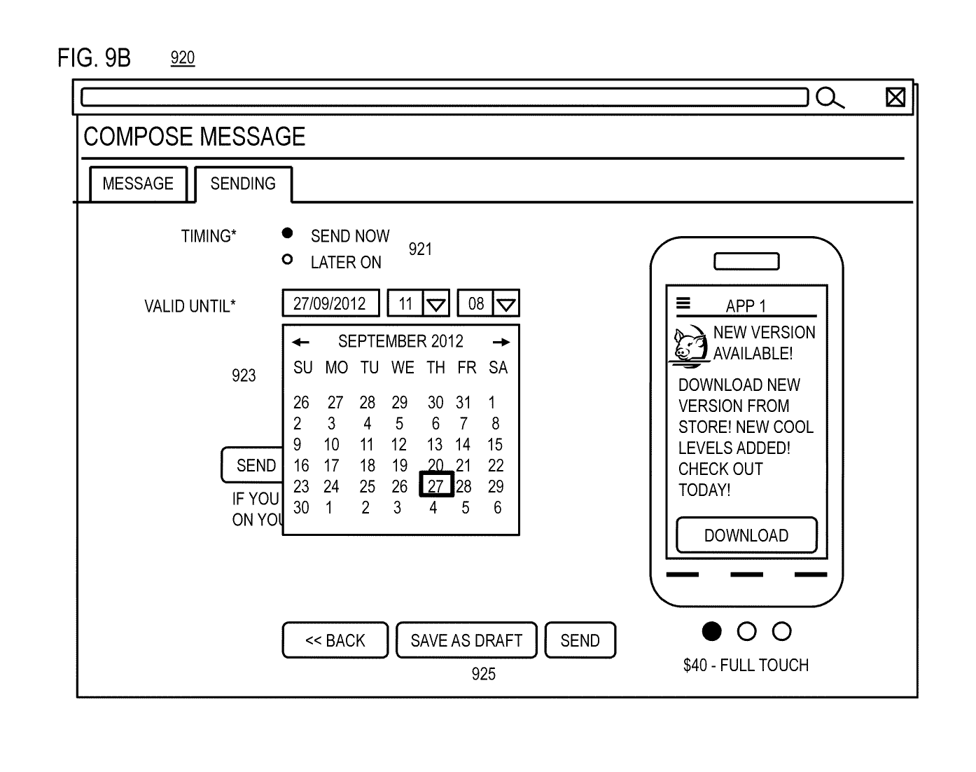

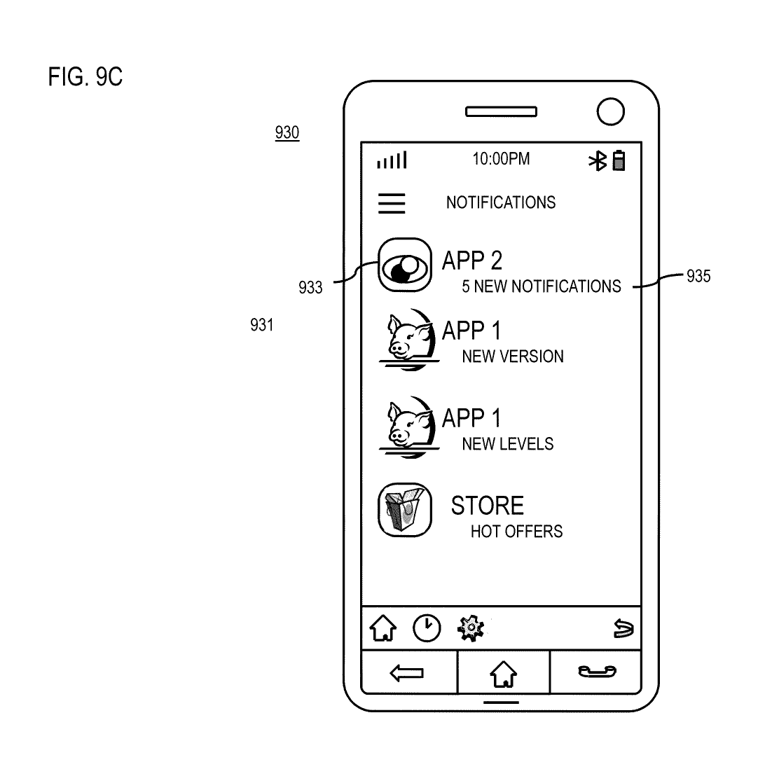

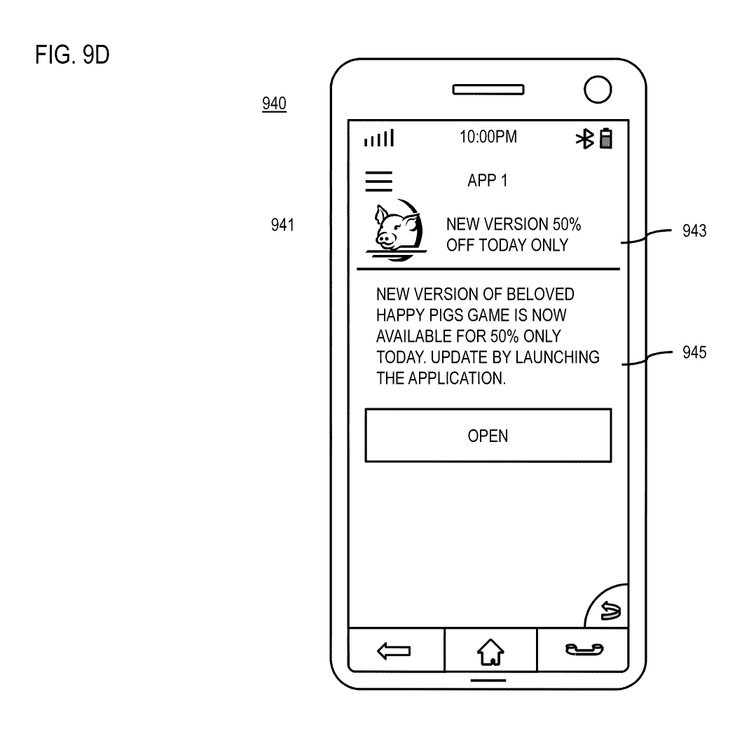

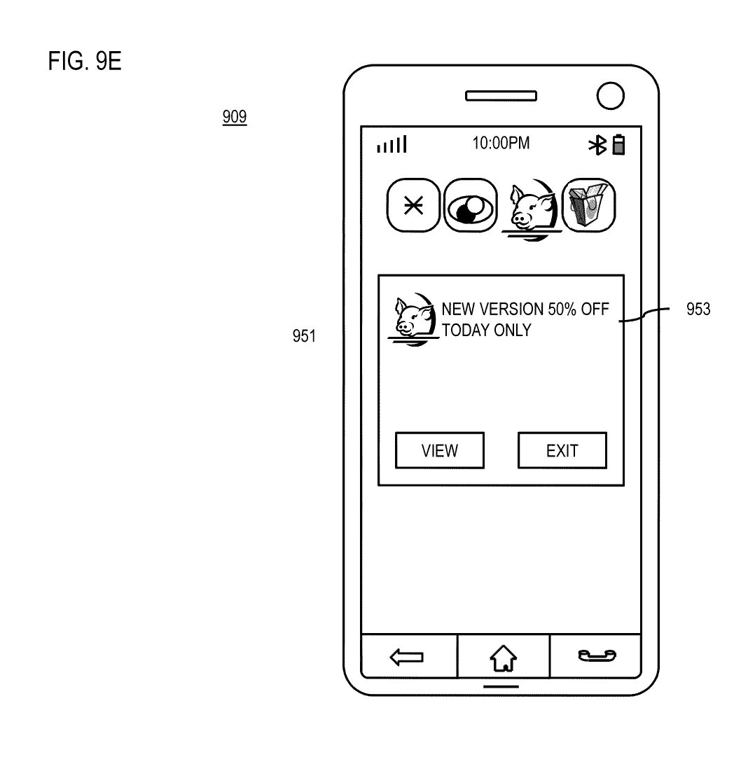

FIGS. 9A-9E are diagrams of user interfaces utilized in the processes of FIG. 3, according to various embodiments. FIG. 9A is a diagram of a console interface 900 for composing one or more messages. For one embodiment, this interface may be a web console interface separate from application servers associated with applications. For example, the composer platform 113 may provide the console may provide independently online, eliminating the need for each application to have its own API for notifications. In one embodiment, the console interface 900 may include a drop-down menu 901 to select an application or group of applications where the message is directed. For example, the drop-down menu may include applications with associated application channels. Next, console interface 900 may provide a title line 903. In one embodiment, the title line 903 may have a maximum character length. In one embodiment, the content of the title line 903 may help publishers categorize or organize messages. For example, the console interface 900 may permit publishers to re-use messages or compile a set of message templates or standard messages. In one instance, console interface 900 may permit publishers to search for these methods using the title. Message box 905 may provide publishers a space to create their messages. In one embodiment, message box 905 may include a character counter. Further message customization may be available via button options 907 where publishers may opt to add buttons or additional functionality to the message and name the buttons. Application identifier 909 may provide further fine-grain selection of applications. For example, different versions of an application may be denoted by different application identifiers. Entering a particular identifier may permit publishers to further target message distribution. Preview 911 may display a version of how users see the notification. Pricing information 913 may also be part of the console interface 900. The console interface 900 may include more than one page of options. Page button 915 may permit publishers to move on to more message creation options.

FIG. 9B is a further diagram 920 of a console interface 900 for composing one or more messages. In one embodiment, the console interface 920 may include timing options 921 for example, for sending immediately, or setting a future time. The timing options 921 may then offer calendar 923. Upon message completion, console interface 920 may permit further publication options 925, including modifying the message (by revisiting console interface 900), saving the message as a draft, or sending.

FIG. 9C is a diagram of a user interface 930 for composing one or more messages. For example, the user interface 930 may include a list of notifications 931. The list 931 may include application names, application icons 933, or a combination thereof for immediate identification of the applications. In one embodiment, the list 931 may also include an abbreviated version 935 of the message. For example, the abbreviated version may be the title of the message. In another embodiment, the list 931 may show a caption 937 representing that there are multiple notifications. For example, list 931 may display caption 937 when there is more than one message from the application.

FIG. 9D is a diagram of a display 940 for one or more messages. The display 940 may include the application name and icon 941, as well as the title 943 of the message. Message text 945 may be displayed in the center of the screen, along with a prompt 947 for the user. FIG. 9E is a diagram 950 of an alternate display 950 for one or more messages. Here, the display 950 may include only an application icon 951 along with an abbreviated message, for instance, the message title 953. The display 950 may include prompts 955 for the user to see the full message, or exit. In contrast to display 940, display 950 may not take up the entire screen.

The processes described herein for distributing notifications from developers to installed applications via a notification enabler separate from the applications may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

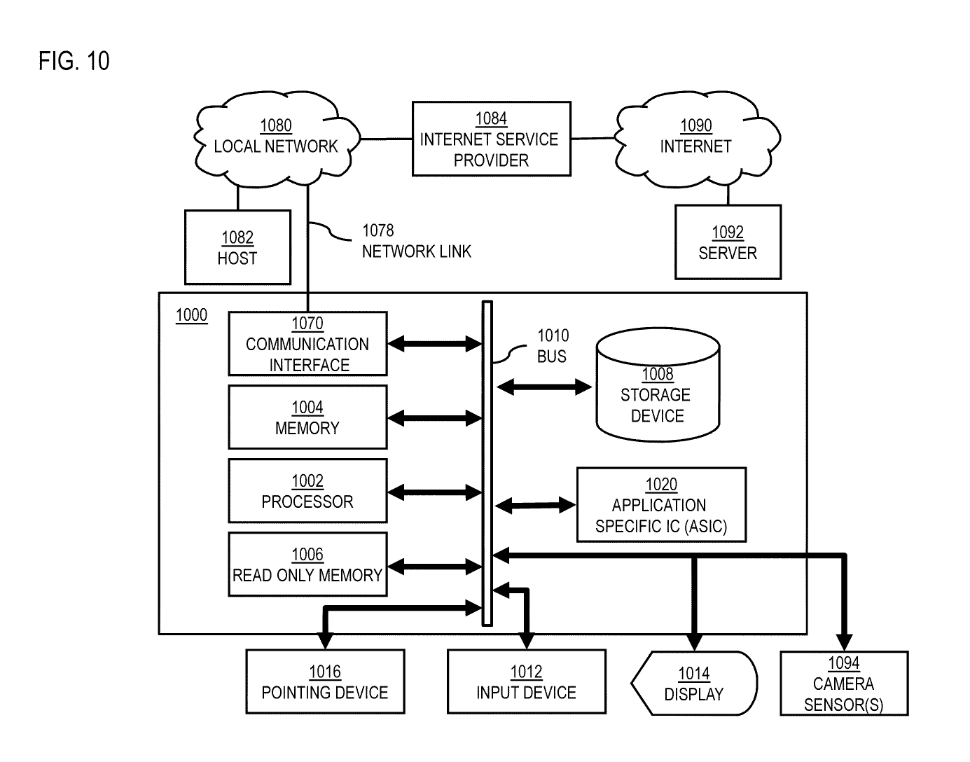

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to initiate a call using a multiple antenna system as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps distributing notifications from developers to installed applications via a notification enabler separate from the applications.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related distributing notifications from developers to installed applications via a notification enabler separate from the applications. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or any other dynamic storage device, stores information including processor instructions for distributing notifications from developers to installed applications via a notification enabler separate from the applications. Dynamic memory allows information stored therein to be changed by the computer system 1000. RANI allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or any other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for distributing notifications from developers to installed applications via a notification enabler separate from the applications, is provided to the bus 1010 for use by the processor from an external input device 1012, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT), a liquid crystal display (LCD), a light emitting diode (LED) display, an organic LED (OLED) display, a plasma screen, or a printer for presenting text or images, and a pointing device 1016, such as a mouse, a trackball, cursor direction keys, or a motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of ASICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 105 for distributing notifications from developers to installed applications via a notification enabler separate from the applications to the UE 101.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 590.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 500 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or any other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to initiate a call using a multiple antenna system as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of functions. Chip set or chip 1100, or a portion thereof, constitutes a means for performing one or more steps of distributing notifications from developers to installed applications via a notification enabler separate from the applications.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to distribute notifications from developers to installed applications via a notification enabler separate from the applications. The memory 1105 also stores the data associated with or generated by the execution of the inventive steps.

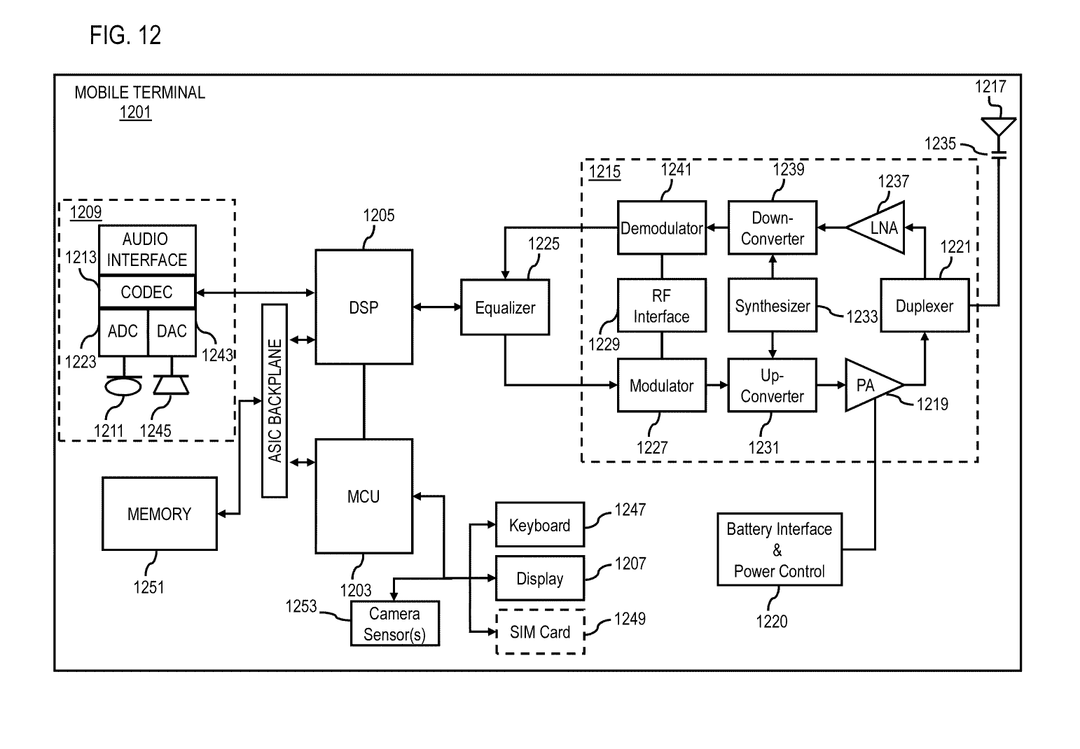

FIG. 12 is a diagram of exemplary components of a mobile terminal (e.g., handset) for communications, which is capable of operating in the system of FIG. 1, according to one embodiment. In some embodiments, mobile terminal 1201, or a portion thereof, constitutes a means for performing one or more steps of distributing notifications from developers to installed applications via a notification enabler separate from the applications. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of distributing notifications from developers to installed applications via a notification enabler separate from the applications. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU).

The MCU 1203 receives various signals including input signals from the keyboard 1247. The keyboard 1247 and/or the MCU 703 in combination with other user input components (e.g., the microphone 1211) comprise a user interface circuitry for managing user input. The MCU 1203 runs a user interface software to facilitate user control of at least some functions of the mobile terminal 1201 to distribute notifications from developers to installed applications via a notification enabler separate from the applications. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RANI memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining by a processor at least one application installed on at least one device, wherein the at least one application is different from the one or more programs;
determining by the processor one or more notification channels associated with the at least one application;
registering by the processor the least one application to the one or more notification channels; and
routing by the processor of one or more messages over the one or more notification channels based, at least in part, on the registration.

2. A method of claim 1, further comprising:
determining one or more initial messages routed to the at least one application, the at least one device, or combination thereof.

3. A method of claim 2, further comprising:
determining to present the one or more initial messages in a notification user interface associated with a notification enabler of the at least one device.

4. A method of claim 3, further comprising:
requesting preference information associated with the one or more initial messages; and
determining to present one or more subsequent messages in the notification user interface based, at least in part, on the preference information, and
wherein the preference information is based on interactions with one or more notifications received from the at least one device.

5. A method of claim 1, further comprising:
receiving the one or more messages to be carried on the one or more notification channels via a console interface presented to one or more publishers associated with the at least one application.

6. A method of claim 5, wherein the console interface includes, at least in part, a web console interface that is separate from one or more application servers associated with the at least one application.

7. A method of claim 5, further comprising:
identifying the at least one application, the one or more publishers associated with the at least one application, or a combination thereof through at least one application store; and
creating the one or more notification channels based, at least in part, the identification.

8. A method of claim 7, further comprising:
validating the one or more publishers based, at least in part, on the identifying, the at least one application store, or a combination thereof,
wherein the creating the one or more notification channels is further based, at least in part, on the validation.

9. A method of claim 7, further comprising:
associating one or more contextual criteria with the one or more notification channels.

10. A method of claim 9, wherein the routing one or more messages over the one or more notification channels is based, at least in part, on whether contextual information associated with the at least one device, the at least one application, or a combination thereof substantially meets the one or more contextual criteria.

11. An apparatus comprising:
at least one processor; and
at least one memory including computer program code for one or more programs, the at least one memory and the computer program code configured to, with the at least one processor, cause the apparatus to perform at least the following,
cause a determination of at least one application installed on at least one device, wherein the at least one application is different from the one or more programs;
cause a determination of one or more notification channels associated with the at least one application;
cause a registration of the least one application to the one or more notification channels; and
cause a routing of one or more messages over the one or more notification channels based, at least in part, on the registration.

12. An apparatus of claim 11, wherein the apparatus is further caused to:
cause a determination of one or more initial messages routed to the at least one application, the at least one device, or combination thereof.

13. An apparatus of claim 12, wherein the apparatus is further caused to:
cause a determination to present the one or more initial messages in a notification user interface associated with a notification enabler of the at least one device.

14. An apparatus of claim 13, wherein the apparatus is further caused to:
cause a request for preference information associated with the one or more initial messages; and
cause a determination to present one or more subsequent messages in the notification user interface based, at least in part, on the preference information, and
wherein the preference information is based on interactions with one or more notifications received from the at least one device.

15. An apparatus of claim 11, wherein the apparatus is further caused to:
cause a reception of the one or more messages to be carried on the one or more notification channels via a console interface presented to one or more publishers associated with the at least one application.

16. An apparatus of claim 15, wherein the console interface includes, at least in part, a web console interface that is separate from one or more application servers associated with the at least one application.

17. An apparatus of claim 15, wherein the apparatus is further caused to:
cause an identification of the at least one application, the one or more publishers associated with the at least one application, or a combination thereof through at least one application store; and
cause a creation of the one or more notification channels based, at least in part, the identification.

18. A method of claim 17, further comprising:
cause a validation of the one or more publishers based, at least in part, on the identifying, the at least one application store, or a combination thereof,
wherein the creation of the one or more notification channels is further based, at least in part, on the validation.

19. A method of claim 17, further comprising:
cause an association of one or more contextual criteria with the one or more notification channels.

20. An apparatus of claim 19, wherein the routing one or more messages over the one or more notification channels is based, at least in part, on whether contextual information associated with the at least one device, the at least one application, or a combination thereof substantially meets the one or more contextual criteria.
